(19) United States
(12) Patent Application Publication
(10) Pub. No.: US 2017/0236335 A1
(43) Pub. Date: Aug. 17, 2017

(54) SYSTEM AND METHOD FOR MANIPULATING ACCELERATION STRUCTURES

(71) Applicant: Hue AS, Oslo (NO)

(72) Inventor: Paul Endre Endresen, Houston, TX (US)

(21) Appl. No.: 15/041,222

(22) Filed: Feb. 11, 2016

(51) Int. Cl. G06T 19/20; G06T 17/20; G06T 17/10

(52) U.S. Cl. CPC G06T 19/20; G06T 17/10; G06T 17/20; G06T 2200/04

(57) ABSTRACT

A system and method for computational geometry including: receiving a data set containing geometric primitives with vertices; sorting and re-indexing the vertices using a first ranking system; sorting the geometric primitives using a second ranking system; creating a spatial acceleration structure for the data set that: describes the plurality of geometric primitives in a multi-dimensional space, applies a unique index to each of the vertices of the geometric primitives, and contains leaf-nodes containing geometric primitives; sorting within each leaf-node, the geometric primitives using a third ranking system, wherein the geometric primitives within each leaf-node of the acceleration structure are reordered to have vertices with consecutive indices; optionally compressing the sorted primitives within the leaf-nodes using a compression algorithm; and processing the primitives using the acceleration structure.

### FIELD OF INVENTION

The present invention relates to improved storage and response times for computational geometry.

### BACKGROUND OF THE INVENTION

Computational geometry may use various geometric primitives to create a graphical image. The primitives may include, for example, points, triangles and/or polygons. Computational geometry algorithms for processing and rendering often use acceleration structures to assist in localizing data to improve performance. For example, in computing the intersections between two data sets made of triangles, two acceleration structures may be used to minimize the number of triangles from each data set that must be considered for intersection.

The amount of data for even a relatively simple geometric dataset can be large and the creation of acceleration structures only increases the amount of data. Compression is often used to assist in managing such large amounts of data. However, many traditional acceleration structures, which are created based on the order of primitives in the original data, may not be used on compressed data, because compression algorithms generally re-order the primitives. What is needed are techniques to create or manipulate compact or minimal acceleration structures with a reduced data footprint that may simultaneously operate on a optionally compressed version of the original data.

### SUMMARY

The invention may provide a computer-implemented method for computational geometry, the method comprising: receiving, by one or more processors, a data set containing a plurality of geometric primitives, wherein the geometric primitives of the plurality of geometric primitives include one or more vertices; sorting, by the one or more processors, the one or more vertices using a first ranking system to calculate one or more revised indices; re-indexing, by the one or more processors, the one or more vertices of the geometric primitives using the revised indices; sorting, by the one or more processors, the geometric primitives using a second ranking system; creating, by the one or more processors, a spatial acceleration structure for the data set, wherein the spatial acceleration structure: describes the plurality of geometric primitives in a multi-dimensional space, applies a unique index to each of the one or more vertices of the geometric primitives, and contains one or more leaf-nodes, wherein the one or more leaf-nodes contain one or more geometric primitives of the plurality of geometric primitives; sorting, by the one or more processors, within each of the one or more leaf-nodes of the acceleration structure, the geometric primitives of the plurality of geometric primitives using a third ranking system, wherein the one or more geometric primitives within each of the one or more leaf-nodes of the acceleration structure are reordered to have vertices with consecutive indices; and processing, by the one or more processors, the primitives using the acceleration structure.

The invention may also provide a computer-implemented system comprising: a storage medium to: store a data set containing a plurality of geometric primitives, wherein the geometric primitives of the plurality of geometric primitives include one or more vertices; one or more processors to: sort the one or more vertices using a first ranking system to calculate one or more revised indices; re-index the one or more vertices of the geometric primitives using the revised indices; sort the geometric primitives using a second ranking system; create a spatial acceleration structure for the data set, wherein the spatial acceleration structure: describes the plurality of geometric primitives in a multi-dimensional space, applies a unique index to each of the one or more vertices of the geometric primitives, and contains one or more leaf-nodes, wherein the one or more leaf-nodes contain one or more geometric primitives of the plurality of geometric primitives;

sort the geometric primitives of the plurality of geometric primitives, within each of the one or more leaf-nodes of the acceleration structure, using a third ranking system, wherein the one or more geometric primitives within each of the one or more leaf-nodes of the acceleration structure are reordered to have vertices with consecutive indices; and store the acceleration structure in the storage medium; and process the primitives using the acceleration structure.

In another embodiment, the invention may also provide a non-transitory computer-readable medium holding one or more computer-executable instructions to: receive a data set containing a plurality of geometric primitives, wherein the geometric primitives of the plurality of geometric primitives include one or more vertices; sort the one or more vertices using a first ranking system to calculate one or more revised indices; re-index the one or more vertices of the geometric primitives using the revised indices; sort the geometric primitives using a second ranking system; create a spatial acceleration structure for the data set, wherein the spatial acceleration structure: describes the plurality of geometric primitives in a multi-dimensional space, applies a unique index to each of the one or more vertices of the geometric primitives, and contains one or more leaf-nodes, wherein the one or more leaf-nodes contain one or more geometric primitives of the plurality of geometric primitives; sort the geometric primitives of the plurality of geometric primitives, within each of the one or more leaf-nodes of the acceleration structure, using a third ranking system, wherein the one or more geometric primitives within each of the one or more leaf-nodes of the acceleration structure are reordered to have vertices with consecutive indices; and process, by the one or more processors, the primitives using the acceleration structure.

### BRIEF DESCRIPTION OF THE DRAWINGS

The foregoing and other features and advantages of the invention will be apparent from the following, more particular description of various embodiments, as illustrated in the accompanying drawings wherein like reference numbers generally indicate identical, functionally similar, and/or structurally similar elements. The first digits in the reference number indicate the drawing in which an element first appears. Unless otherwise indicated, the accompanying drawing figures are not to scale.

FIG. 1 depicts a sample graphical image comprising various primitives;

FIG. 2 depicts sample points on a Cartesian plane;

FIG. 3 depicts an optimal localized reordering of the sample points on a Cartesian plane;

FIG. 4 depicts a comparison of the original ordering and the optimal localized reordering of the sample points on a Cartesian plane, and the primitives defined by the sample points;

FIG. 5 depicts an example hierarchical tree data structure;

FIG. 6 depicts an example of optimized vertices and leaf node representation;

FIG. 7 depicts an example flowchart for use in an illustrative embodiment of the invention;

FIG. 8 depicts an example computer processing system that may be used in implementing an embodiment of the present invention.

### DETAILED DESCRIPTION

Illustrative embodiments are discussed in detail below. While specific embodiments are discussed, it should be understood that this is done for illustration purposes only. In describing and illustrating the embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

Furthermore, the embodiments detailed below may be combined into a new embodiment and/or various features of the embodiments described below may be individually combined to form a new embodiment.

All publications cited herein are hereby incorporated by reference in their entirety. As used herein, the term “a” refers to one or more. The terms “including,” “for example,” “such as,” “e.g.,” “may be” and the like, are meant to include, but not be limited to, the listed examples. Additionally, the terms vertex, vertices, point, and/or points may be used interchangeably.

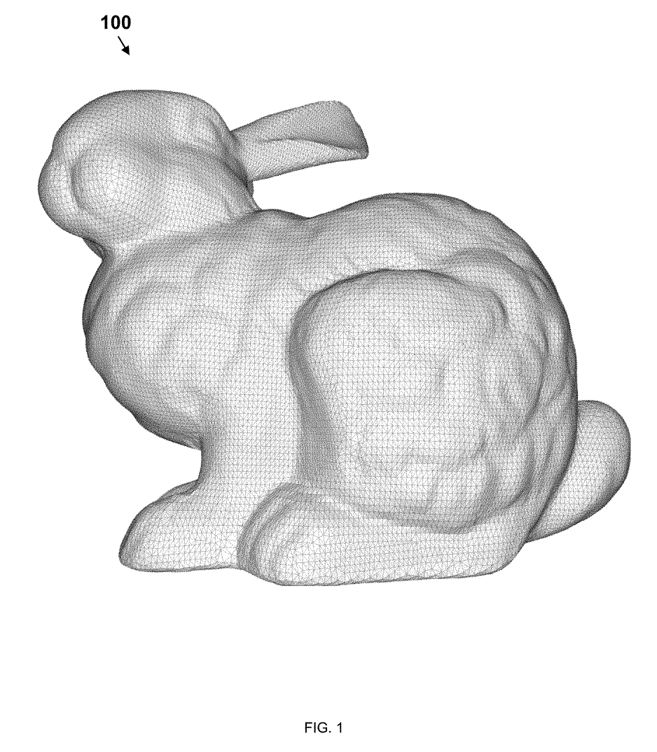

FIG. 1 depicts a sample graphical image 100 comprising various geometric primitives. The primitives may include points, lines, polylines, triangles, polygons, tetrahedrons, and/or polyhedrons, which taken together, represent the entire graphical image 100. Acceleration structures utilizing the primitives may be used to reduce the complexity of searching and/or manipulating graphical image 100. Acceleration structures may use a hierarchical tree data structure and store primitives at the end-nodes (e.g., leaf-nodes). Hierarchical acceleration structures may include, for example, a k-dimensional tree (e.g., k-d tree), bounding volume hierarchy (BVH), bounding interval hierarchy (BIH), or binary space partition (BSP).

Acceleration structures may be used, for example, in ray tracing of data or other algorithms that work with spatial 2D, 3D, and 4D data. Even small graphical images, for example, may comprise many individual triangles and points. A lot of information may be contained in, for example, a billion triangles. For example, not only each point of every triangle but also topology information on how those points connect into triangles and which triangles neighbor one another using a shared edge defined by a pair of points.

With so much information, it is common to compress the data. However, a problem exists because traditional compression algorithms re-order the primitives in the original data set, while traditional acceleration structures are created based on the order of primitives in the original data set, creating a conflict between compression algorithms and acceleration structures. Traditionally, compressed data would need to be decompressed into memory before the data could be used. Accordingly, in the traditional compression scheme, no random access to data is provided. The use of acceleration structures may provide random access to a desired triangle, for example, based on a desired region of interest. Described herein are techniques for creating and using an acceleration structure that provides for compressible data that may be quickly searched and utilized. This may produce faster computational times and a reduced memory footprint.

Typical acceleration structures tend to increase the amount of data, creating more data to provide improved processing speed. The techniques described herein create an acceleration structure that may reduce the size of the data while providing for data that can be quickly searched.

A typical example is a data set that contains over 1.1 billion data points and N triangles. An example data set may be provided from large simulation models, such as Computational Fluid Dynamics (CFD). For example, large simulations of flow and pressure of a gas or liquid. In an embodiment, when utilizing this data, a spatial tree structure for the uncompressed data may be created. Then, based on the spatial tree structure, all the triangles and the points may be spatially localized. For example, the points in memory may be reordered according to the spatial structure. That means the points close to each other spatially will also be close in memory. Additionally, the indexes of the points would also be very close to each other.

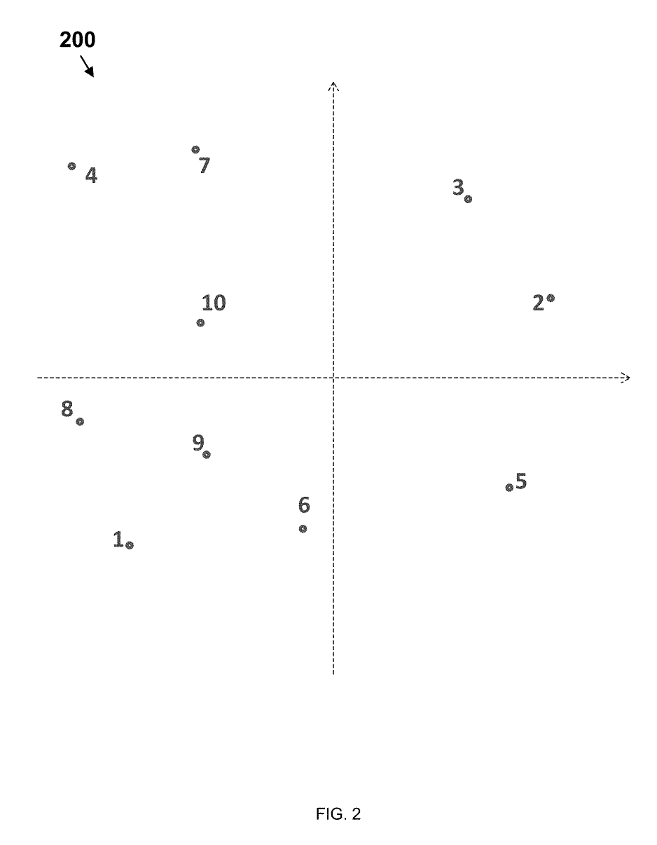

FIG. 2 depicts sample points on a 2D Cartesian plane. The order of the points placed on the plane may be in the order of the original data input. The data points may not be ordered in a spatially and/or algorithmically optimal way (e.g., a model may be potentially built up by many Boolean operations of multiple primitives, where the data points may appear to be random). For example, there may be no coherence in how the data points are ordered relative to their x-y positions. The numbers 1-10 of FIG. 2 correspond to the order of the points.

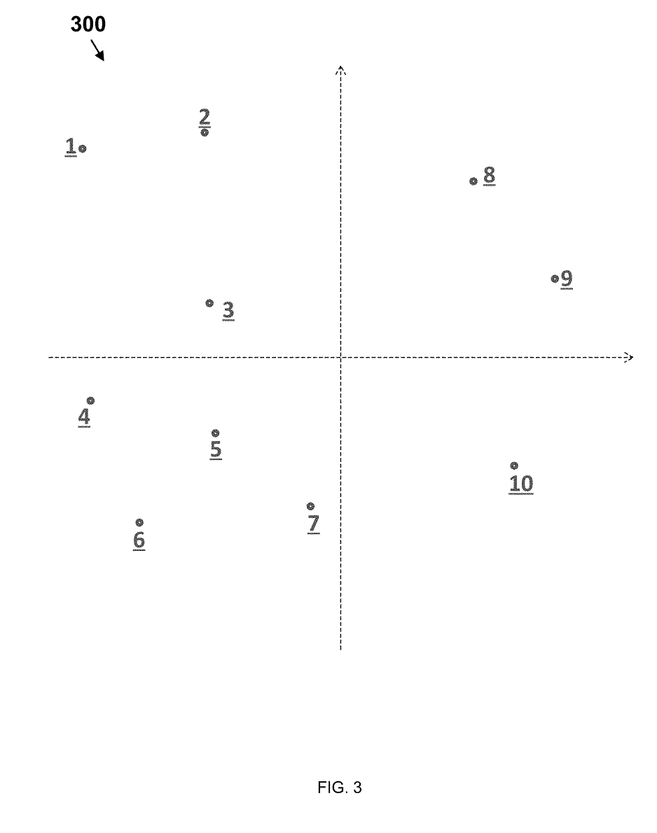

FIG. 3 depicts an optimal reordering of the sample points on the 2D Cartesian plane in one embodiment of the invention. Wherein optimal means the ordered result of the first ranking method described below, which allows for faster access and processing by a computer processor. In FIG. 3, the points on the plane may be sorted so that the points are spatially ordered based on the location of the points. The points may be re-indexed based on this new sort. For example, the points next to each other in space will likely also have a close index.

In another example, a thousand points may be placed on a 2D Cartesian plane with no coherence in how the points are ordered relative to what their x-y positions are in space. For example, point 0 may be in the bottom right hand corner, point 1 may be in the bottom left, point 2 in the top right, and then point 3 in the top right. In one embodiment, the data points may be analyzed and re-indexed so that, for example, the points in the top left quadrant and top left corner are points 0-250; and then in the top right, those are 251-500, etc. Often, data analysis and manipulation may only be required in a particular section, e.g., the top left-hand corner. This may be determined from the acceleration structure. Branches in the acceleration tree structure may be spatially bound, so a tree branch only contains a spatially local section of the model. For example, a bounding box may exist for each branch that defines the extent of each branch and its corresponding sub-branches. Accordingly, the points in the top-left corner may need to be iterated over. Once the data has been reordered, the requested points in the top-left corner may have indexes very close to each other. For example, operations may be performed on 0, 1, 2, 3, 4, 5, 6, 7, for example, not seemingly random indexes, and those sorted indexes actually represent where they are in memory. So, for example, point 0 is at some location in the computer's memory and point 1 follows point 0. There are many benefits to operating on things in memory that are right next to each other (e.g., cache coherency). So, not only are the points going to be closer in memory, but the indexes themselves, 0, 1, 2, 3, 4, 5, 6, are numbers that are close to each other. As the indexing deltas are much smaller, the deltas may be represented with smaller numbers (e.g., an index delta of max 256 may be contained in a single byte). Accordingly, a decrease in typical acceleration tree structure size while an increase in performance is achieved.

Additionally, because of the resorting, less information may need to be stored. For example, assume that points start at 1,000,000 and go to 1,001,000. In this example, the index location may be stored using the numbers 0-999, a thousand numbers, rather than storing the full index of every point (e.g., 1,000,001, 1,000,002, etc.). Based on starting at 1,000,000 we determine that the desired point is x away from 1,000,000. This may reduce the amount of information that needs to be stored. For example, instead of storing the full index of each vertex, of each point, just the offset from 1,000,000 will be stored.

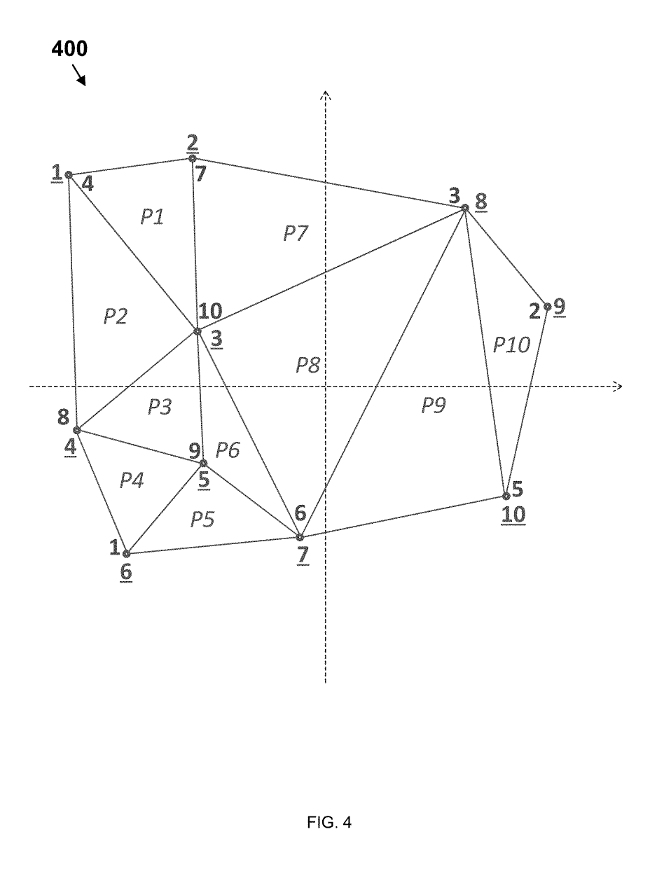

FIG. 4 depicts a comparison of the original ordering (e.g., FIG. 2) and the optimal reordering (e.g., FIG. 3, underlined) of the sample points on a single Cartesian plane, and the primitives made up by these sample points. Table 1 below shows the primitives using the original ordering of FIG. 2 compared to the more optimal ordering of FIG. 3. (S) in the table signifies the start vertex index, and as such has no delta to a previous vertex.

TABLE 1

| | | | Δv = |
|---|---|---|---|
| | Original | Optimal | vₙ-vₙ₋₁ |
| p1 | 4,7,10 | 1,2,3 | (S),1,1 |
| p2 | 4,10,8 | 1,3,4 | −2,2,1 |
| p3 | 10,9,8 | 3,5,4 | −1,2,−1 |
| p4 | 8,9,1 | 4,5,6 | 0,1,1 |
| p5 | 9,6,1 | 5,7,6 | −1,2,−1 |
| p6 | 10,6,9 | 3,7,5 | −3,4,−2 |
| p7 | 7,10,3 | 2,8,3 | −3,6,−3 |
| p8 | 10,3,6 | 3,8,7 | 0,5,−1 |
| p9 | 6,3,5 | 7,8,10 | 0,1,2 |
| p10 | 3,2,5 | 8,9,10 | −2,1,1 |

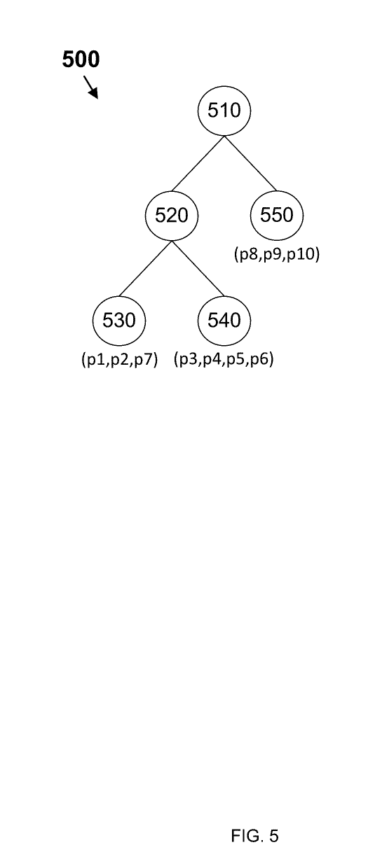

FIG. 5 depicts an example balanced hierarchical tree data structure 500, where the primitives are sorted using a second ranking method. A second ranking system may sort primitives in an order which is more natural for computational geometry algorithms.

Ensuring that when algorithms walk the geometry, nearby primitives are close in memory. Examples of such sorting may be distance to each primitive's center point, shared vertices ordering, and more. Hierarchical tree data structure 500 contains root node 510 that has two children, inner node 520 and leaf node 550. Leaf nodes may also be referred to as external nodes, end nodes, outer nodes, and/or terminal nodes. Leaf nodes 530 and 540 both have inner node 520 for a parent. In a conventional setting, each leaf node 530, 540, and 550 in the tree-structure could store primitives with random ordered vertices, for example, point 5,000; point 11,000; point 2,000,000; point 3,000,000; etc. However, when the data is resorted, chunks of continuous indices are inside each of these spatial nodes in an acceleration structure. Table 2 below shows the primitives and their vertex deltas reordered according to the second ranking method used in FIG. 5. (S) in the table signifies the start vertex, and as such has no delta to a previous vertex.

TABLE 2

| | | | Δv = |
|---|---|---|---|
| | Original | Optimal | vₙ-vₙ₋₁ |
| p1 | 4,7,10 | 1,2,3 | (S),1,1 |
| p2 | 4,10,8 | 1,3,4 | −2,2,1 |
| p7 | 7,10,3 | 2,8,3 | −2,6,−3 |
| p3 | 10,9,8 | 3,5,4 | (S),2,−1 |
| p4 | 8,9,1 | 4,5,6 | 0,1,1 |
| p5 | 9,6,1 | 5,7,6 | −1,2,−1 |
| p6 | 10,6,9 | 3,7,5 | −3,4,−2 |
| p8 | 10,3,6 | 3,8,7 | (S),5,-1 |
| p9 | 6,3,5 | 7,8,10 | 0,1,2 |
| p10 | 3,2,5 | 8,9,10 | −2,1,1 |

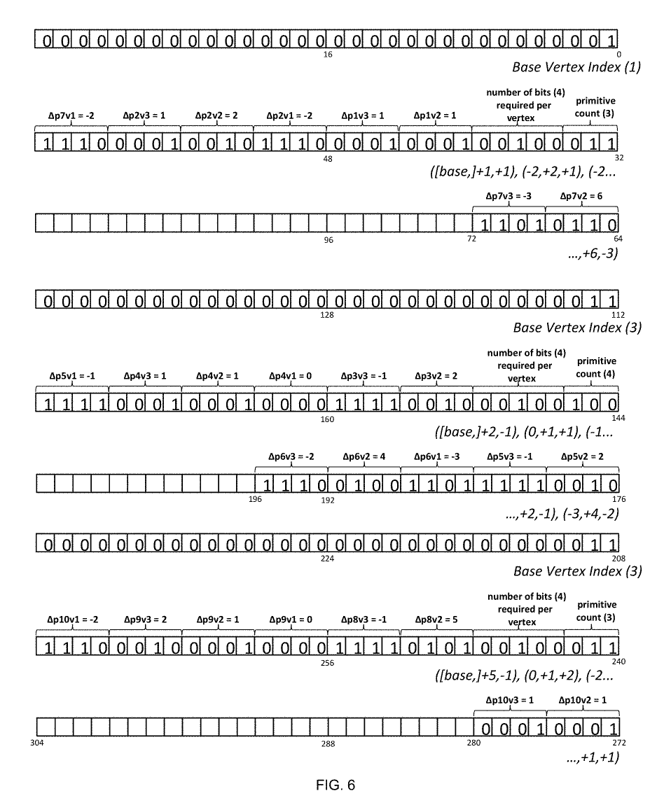

FIG. 6 depicts an example of optimized vertices and leaf node representation of FIG. 5. Additional space saving may occur when, for each example triangle, only the delta to the next primitive is stored. Table 2, for example includes 10 primitives with 3 vertex indices per primitive, where each vertex index may be 32 bits. Accordingly, 10 primitives×3 vertices per primitive×32 bits per vertices=960 bits for original (pre-optimal) leaf node. Once optimized, the 960 bits may be reduced to 304 bits (e.g., 960 bit:304 bit=3.2:1 compression ratio). In one embodiment, an average of 2 bits was needed to describe the next index, instead of the traditional 32 bits.

In one example, a typical unsorted data triangle may be made up of vertex 0; 1,000,000 and 340,000, with each full number for the index explicitly stored. Once reordered, the numbers may be close, for example, triangle may now be made up of vertex 0, 5, and 6. Now, the stored information only needs to instruct on the distance to the next index value. For example, from the first index value the next one is 5 away, so 3 bits are needed, and the index after that is 1 away, so 1 bit is needed. Accordingly, there is no longer a need to store the full 32-bits for each individual index.

The topological type or primitive (e.g., triangles, polygons, lines, tetrahedrons, etc.) may determine the appropriate compression algorithm or algorithms used. For example, a particular compression algorithm may be more effective in compressing data representing lines than data representing tetrahedrons. Additionally, each topological type may have different ways of compressing, but what they may have in common after reordering is that the index to the points that they consist of are very close to each other. Because the index to the points that they consist of are very close to each other the data may be compressed very efficiently. Huffman coding, for example, may be used for compression. Typically, when using a hierarchical acceleration structure for computer graphics and computational geometry, primitives will be placed in an end node, and the analysis will always iterate through all of the end nodes. In one embodiment, the entire tree is not compressed, instead, data in the leaf nodes of the acceleration structure may be compressed (e.g., localized compression). When data is needed from a specific leaf node, decompression of data from that specific leaf node may occur.

In one embodiment, a data set with many points may exist. An acceleration structure may be created that describes where each of the points is in space (e.g., location of points in a 3D graph and/or which quadrant). The data may be resorted so that all the points in each quadrant are at consecutive indices (e.g., top left is 0 to 200, bottom left is 201 to 400, top right is 401 to 600, and bottom right is 601 to 800). Then, for every end node, compress the indices of the primitives based on whatever compression scheme is optimal. For example, Huffman coding may be the optimal compression. However, the compression scheme may be chosen based on an analysis of the leaf nodes. For example, a random sampling of leaf nodes may be compressed with a number of various known compression schemes and an analysis of the compression results may determine which compression scheme is appropriate for the tested data set.

In one embodiment, a position either 2d or 3d may be determined. The position may have an x component, a y component, and a z component. The points in the data set may be sorted. For example, the sorting may be performed based on a Z-order curve (i.e., Morton order) as described below. A new number may be created that has three times the bits of the original x/y/z components, with the original x/y/z bits interleaved. For example, bit 0 in the new number comes from bit 0 in the x component; bit 1 in the new number comes from bit 0 in the y component; and bit 2 of the new number comes from bit 0 in z component; and so on. This may be done for all the points, which may be then re-sorted based on the new number. Such a sorting will result in, on average, very close locality in space. That is, points very close together in the sorting will tend to be very close in space. Such a sorting allows for processing every point in its sorted order with the least amount of moving around in the data in memory. Other sort algorithms may also be used, such as the Hilbert curve. Several sorting algorithms may be used on a data set to determine the most efficient sorting algorithm for the particular data set.

Once an improved acceleration structure has been created and a large mesh or initial points are now represented in as local and small a way as possible, algorithms may be initiated that iterate through the data, or the representative graphic may be rendered. With the improved acceleration structure, spatial algorithms, for example, may be accelerated. The acceleration structure may be used to quickly locate graphical information.

In one embodiment a single acceleration structure may be used by several hundred algorithms in computational geometry, such as intersections, distance, and search, all using the same acceleration structure. The improved acceleration structure benefits this usage as the acceleration structure provides that the data is close in memory and takes less memory. Accordingly, when reading from memory, a system accessing the acceleration structure may be reading from memory that is close and may not be required to jump around to distant addresses of the memory. This implies that the processor is able to maintain more of the computational data in its internal fast caches, thus improving cache coherency, and again performance.

In one embodiment, billions of tetrahedrons may be present. Billions of tetrahedrons may take up a considerable amount of memory so compression may be required. Conventional techniques require decompression of the whole data set to perform one frame of ray tracing, because there is no conventional way to compress and get random access to the data through an acceleration structure. However, through the use of the improved acceleration structure described herein, the whole data set does not need to be decompressed. For example, the sub-branches may be compressed individually, so only the branches of interest are decompressed.

In one embodiment, what is being compressed is not the vertices themselves, but rather the indexes to the vertices that have been now reordered. This minimizes the amount of data required for vertex indices. Compression depends on the different topology types that may make up the ratio. For different topologies, the ratio of the size of vertex index data to vertex data may vary. For example, a triangle may be defined by providing the indexes of the three vertices that make up the triangle and a tetrahedron may be defined by providing the indexes of the four vertices that make up the tetrahedron. Then, in an example data set, the same vertex may be part of many triangles/tetrahedra, as described above. An example compression ratio for triangles may be approximately 1:3, while tetrahedrons may be about 1:20 (e.g., 20 times as much data per indices for the actual vertex positions). Accordingly, it is typically more advantageous to compress the vertex indices rather than compressing the actual vertices. The indices basically describe the edges.

In one experiment, data that contained 16 gigabytes of tetrahedra defined from vertex indices was reduced to about 2.3 gigabytes after running the invention described herein.

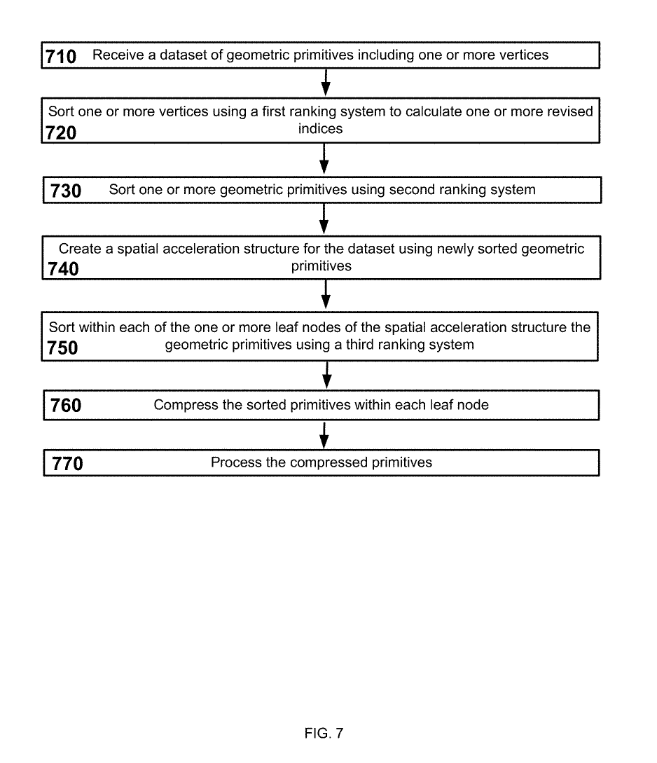

FIG. 7 depicts example flowchart in an illustrative embodiment. Flow may start at 710. In 710, a dataset of a plurality of geometric primitives may be received (e.g., the dataset corresponding to FIG. 1). The geometric primitives may include vertices. The geometric primitives may include points, lines, polylines, triangles, polygons, tetrahedrons, and/or polyhedrons. From 710, flow may move to 720.

In 720, the one or more vertices of the geometric primitives may be sorted using a first ranking system. The first ranking system may calculate one or more revised indices for the vertices of the geometric primitives, which are then used to re-index each of the vertices of the geometric primitives. The first ranking system may use, for example, a Z-order curve (Morton ordering) and/or a Hilbert curve. In one embodiment, new values may be created by interleaving the bit values of each x, y, and z values of the vertices. From 720, flow may move to 730.

In 730, the geometric primitives may be sorted using a second ranking system. A second ranking system may sort primitives in an order which is more natural for computational geometry algorithms. Ensuring that when algorithms walk the geometry, nearby primitives are close in memory. Examples of such sorting may be distance to each primitive's center point, shared vertices ordering, and more. From 730, flow may move to 740.

In 740, a spatial acceleration structure for the dataset may be created using the newly sorted geometric primitives. The spatial acceleration structure may describe the plurality of geometric primitives in a multi-dimensional space. The multi-dimensional space may be two-dimensional (e.g., x and y values) or three-dimensional (e.g., x, y, and z values) or any number of unique dimensions. A unique index may be applied to each of the vertices of the geometric primitives. The spatial acceleration structure may contain leaf-nodes. The leaf-nodes may contain geometric primitives from the plurality of geometric primitives. From 740, flow may move to 750.

In 750, a third ranking system may be used to sort geometric primitives within each of the one nodes of the spatial acceleration structure. The third ranking system may result in reordering the geometric primitives within each of the leaf-nodes of the acceleration structure to have vertices of consecutive indices. The third ranking system may be based on ranking the smallest index or other rankings to reduce the number of bits required to describe the representation. The reordering may include storing primitives in memory such that the primitives assigned to a region are stored consecutively in the address space of memory. From 750, flow may move to 760.

In 760, the sorted primitives may be optionally compressed within each leaf node. The compression algorithm used for compressing the primitives may be based on the structure of the geometric primitives. Compressing the sorted primitives may include, for example, compressing the indices of the vertices between the sorted primitives for each leaf-node. In another embodiment, the memory footprint of the spatial acceleration structure may be further reduced by replacing values in the primitives with a calculated difference between primitives. An offset may be calculated from a first primitive of the sorted primitives to a next primitive of the sorted primitives and the calculated offset may be stored in the next primitive. The leaf nodes, while already potentially representing the original data in the more efficient way, may in turn be compressed using a traditional compression algorithm, further decreasing the size of the data.

In an embodiment, compression of the leaf nodes may be optional. In 720-750, the data may be reorganized in such a way that the original data may be represented with smaller structures. As the data restructuring represents the original data but in a smaller space, the data may be considered as being effectively compressed, even without applying a compression algorithm. From 760, flow may move to 770.

In 770, the compressed or non-compressed primitives may be processed. Processing may include at least one of rendering the primitives or calculating a spatial algorithm using the primitives. Flow may end at 770.

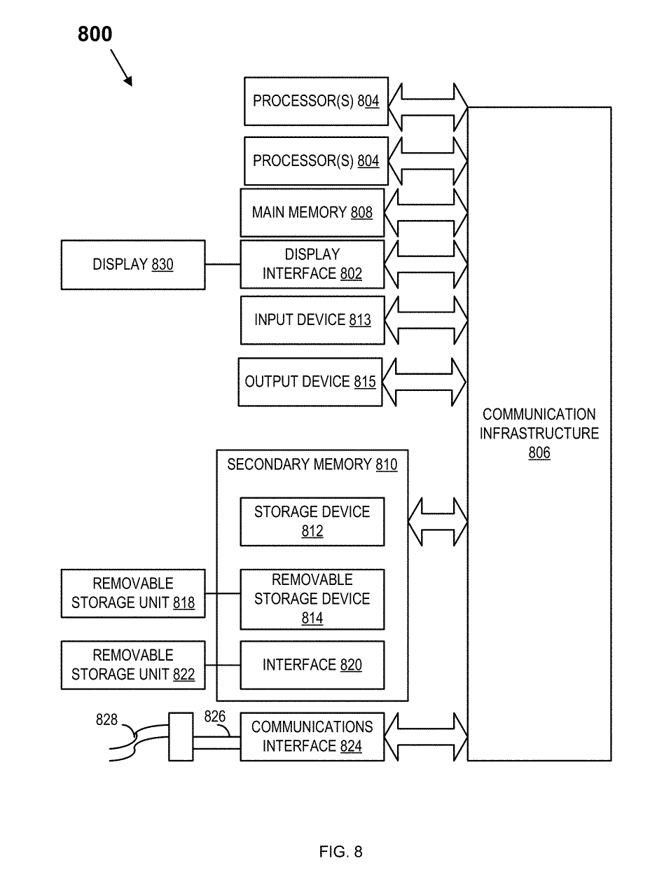

FIG. 8 depicts an example computer system that may be used in implementing an illustrative embodiment of the present invention. Specifically, FIG. 8 depicts an illustrative embodiment of a computer system 800 that may be used in computing devices such as, e.g., but not limited to, standalone, client, server devices, or system controllers. FIG. 8 depicts an illustrative embodiment of a computer system that may be used as client device, a server device, a controller, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 800 is shown in FIG. 8, depicting an illustrative embodiment of a block diagram of an illustrative computer system useful for implementing the present invention. Specifically, FIG. 8 illustrates an example computer 800, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/Windows 8, etc. available from MICROSOFT® Corporation of Redmond, Wash., U.S.A.; UNIX® or Linux (e.g., Red Hat, CentOS, Ubuntu, Debian, Fedora, openSUSE, SUSE LE, GNULinux, RTLinux, QNX, AIX, NetBSD, etc); or an Apple computer executing MAC® OS or iOS from Apple® of Cupertino, Calif., U.S.A; or a smartphone running iOS, Android, or Windows mobile, for example. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 800 is shown in FIG. 8. Other components of the invention, such as, e.g., (but not limited to) a computing device, a communications device, a telephone, a personal digital assistant (PDA), an iPhone, a 3G/4G, LTE wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 8. In an illustrative embodiment, services may be provided on demand using, e.g., an interactive television device (iTV), a video on demand system (VOD), via a digital video recorder (DVR), and/or other on demand viewing system. Computer system 800 may be used to implement the network and components as described above.

The computer system 800 may include one or more processors, such as, e.g., but not limited to, processor(s) 804. The processor(s) 804 may be connected to a communication infrastructure 806 (e.g., but not limited to, a communications bus, cross-over bar, interconnect, or network, etc.). Processor 804 may include any type of processor, microprocessor, or processing logic that may interpret and execute instructions (e.g., for example, a field programmable gate array (FPGA)). Processor 804 may comprise a single device (e.g., for example, a single core) and/or a group of devices (e.g., multi-core). The processor 804 may include logic configured to execute computer-executable instructions configured to implement one or more embodiments. The instructions may reside in main memory 808 or secondary memory 810. Processors 804 may also include multiple independent cores, such as a dual-core processor or a multi-core processor. Processors 804 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention and/or parts of the invention using other computer systems and/or architectures.

Computer system 800 may include a display interface 802 that may forward, e.g., but not limited to, graphics, text, and other data, etc., from the communication infrastructure 806 (or from a frame buffer, etc., not shown) for display on the display unit 801. The display unit 801 may be, for example, a television, a computer monitor, a touch sensitive display device, or a mobile phone screen. The output may also be provided as sound through a speaker.

The computer system 800 may also include, e.g., but is not limited to, a main memory 808, random access memory (RAM), and a secondary memory 810, etc. Main memory 808, random access memory (RAM), and a secondary memory 810, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 810 may include, for example, (but is not limited to) a hard disk drive 812 and/or a removable storage drive 814, representing a floppy diskette drive, a magnetic tape drive, an optical disk drive, a compact disk drive CD-ROM, flash memory, etc. The removable storage drive 814 may, e.g., but is not limited to, read from and/or write to a removable storage unit 818 in a well-known manner. Removable storage unit 818, also called a program storage device or a computer program product, may represent, e.g., but is not limited to, a floppy disk, magnetic tape, optical disk, compact disk, etc. which may be read from and written to removable storage drive 814. As will be appreciated, the removable storage unit 818 may include a computer usable storage medium having stored therein computer software and/or data.

In alternative illustrative embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 822 and interfaces 820, which may allow software and data to be transferred from the removable storage unit 822 to computer system 800.

Computer 800 may also include an input device 803 which may include any mechanism or combination of mechanisms that may permit information to be input into computer system 800 from, e.g., a user or operator. Input device 803 may include logic configured to receive information for computer system 800 from, e.g. a user or operator. Examples of input device 803 may include, e.g., but not limited to, a mouse, pen-based pointing device, or other pointing device such as a digitizer, a touch sensitive display device, and/or a keyboard or other data entry device (none of which are labeled). Other input devices 803 may include, e.g., but not limited to, a biometric input device, a video source, an audio source, a microphone, a web cam, a video camera, and/or other camera.

Computer 800 may also include output devices 815 which may include any mechanism or combination of mechanisms that may output information from computer system 800. Output device 815 may include logic configured to output information from computer system 800. Embodiments of output device 815 may include, e.g., but not limited to, display 801, and display interface 802, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 800 may include input/output (I/O) devices such as, e.g., (but not limited to) input device 803, communications interface 824, connection 828 and communications path 826, etc. These devices may include, e.g., but are not limited to, a network interface card, onboard network interface components, and/or modems.

Communications interface 824 may allow software and data to be transferred between computer system 800 and external devices or other computer systems. Computer system 800 may connect to other devices or computer systems via wired or wireless connections. Wireless connections may include, for example, WiFi, satellite, mobile connections using, for example, TCP/IP, 802.15.4, high rate WPAN, low rate WPAN, 6loWPAN, ISA100.11a, 802.11.1, WiFi, 3G, WiMAX, 4G and/or other communication protocols.

In this document, the terms “computer program medium” and “computer readable medium” may be used to generally refer to media such as, e.g., but not limited to, removable storage drive 814, a hard disk installed in hard disk drive 812, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to computer system 800. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application.

It may also be part of a system for creating an enhanced acceleration structure. Computer system 800 may be used to create a general purpose computer. A general purpose computer may be specialized by storing programming logic that enables one or more processors to perform the techniques indicated herein and one or more of the steps of FIG. 7. Computer system 800 or multiple embodiments of computer system 800 may be used to perform the functions described above.

Embodiments of the present invention may include apparatuses for performing the operations herein. An apparatus may be specially constructed for the desired purposes, or it may comprise a general purpose device selectively activated or reconfigured by a program stored in the device.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents. The embodiments of the present invention that have been described above may contain features that may be removed or combined between the described embodiments to derive additional embodiments.

What is claimed is:

1. A computer-implemented method for computational geometry, the method comprising:
receiving, by one or more processors, a data set containing a plurality of geometric primitives, wherein the geometric primitives of the plurality of geometric primitives include one or more vertices;
sorting, by the one or more processors, the one or more vertices using a first ranking system to calculate one or more revised indices;
re-indexing, by the one or more processors, the one or more vertices of the geometric primitives using the revised indices;
sorting, by the one or more processors, the geometric primitives using a second ranking system;
creating, by the one or more processors, a spatial acceleration structure for the data set, wherein the spatial acceleration structure:
describes the plurality of geometric primitives in a multi-dimensional space,
applies a unique index to each of the one or more vertices of the geometric primitives, and
contains one or more leaf-nodes, wherein the one or more leaf-nodes contain one or more geometric primitives of the plurality of geometric primitives;
sorting, by the one or more processors, within each of the one or more leaf-nodes of the acceleration structure, the geometric primitives of the plurality of geometric primitives using a third ranking system, wherein the one or more geometric primitives within each of the one or more leaf-nodes of the acceleration structure are reordered to have vertices with consecutive indices; and
processing, by the one or more processors, the primitives using the acceleration structure.

2. The computer-implemented method of claim 1, wherein the geometric primitives represent at least one of: a point, a line, a polyline, a triangle, a polygon, a tetrahedron, or a polyhedron.

3. The computer-implemented method of claim 1, wherein the first ranking system uses a Z-order curve (Morton order) or a Hilbert curve.

4. The computer-implemented method of claim 1, wherein the third ranking system is based on smallest index.

5. The computer-implemented method of claim 1, further comprising:
compressing, by the one or more processors, the sorted primitives within the one or more leaf-nodes using a compression algorithm.

6. The computer-implemented method of claim 5, wherein the compression algorithm is determined based on the structure of one or more of the plurality of geometric primitives.

7. The computer-implemented method of claim 5, wherein compressing the sorted primitives includes compressing the indices of the vertices between the sorted primitives for each leaf-node of the one or more leaf-nodes.

8. The computer-implemented method of claim 1, wherein the multi-dimensional space is two or more dimensions.

9. The computer-implemented method of claim 1, wherein the one or more vertices include two or more position coordinate values.

10. The computer-implemented method of claim 9, further comprising:
creating one or more new values, wherein the one or more new values are created by interleaving bit values of each position coordinate values of the one or more vertices, wherein the one or more new values are equally sortable and provide spatially localized distribution through the data set.

11. The computer-implemented method of claim 1, wherein processing the primitives comprises at least one of rendering the primitives or calculating a spatial algorithm using the primitives.

12. The computer-implemented method of claim 1, further comprising:
calculating a difference between a first primitive to another primitive in a leaf-node of the one or more leaf-nodes; and
storing the calculated difference.

13. The computer-implemented method of claim 12, wherein a memory footprint of the data set is reduced by replacing values of the primitives with the calculated difference.

14. The computer-implemented method of claim 1, wherein sorting within each of the one or more leaf-nodes includes storing primitives in a memory of the one or more processors such that the primitives assigned to a region are stored consecutively in a memory address space.

15. The computer-implemented method of claim 1, further comprising:
calculating an offset from a first primitive of the sorted primitives to a next primitive of the sorted primitives; and
storing the calculated offset to the next primitive.

16. A computer-implemented system comprising:
a storage medium to:
store a data set containing a plurality of geometric primitives, wherein the geometric primitives of the plurality of geometric primitives include one or more vertices;
one or more processors to:
sort the one or more vertices using a first ranking system to calculate one or more revised indices;
re-index the one or more vertices of the geometric primitives using the revised indices;
sort the geometric primitives using a second ranking system;
create a spatial acceleration structure for the data set, wherein the spatial acceleration structure:
describes the plurality of geometric primitives in a multi-dimensional space,
applies a unique index to each of the one or more vertices of the geometric primitives, and
contains one or more leaf-nodes, wherein the one or more leaf-nodes contain one or more geometric primitives of the plurality of geometric primitives;
sort the geometric primitives of the plurality of geometric primitives, within each of the one or more leaf-nodes of the acceleration structure, using a third ranking system, wherein the one or more geometric primitives within each of the one or more leaf-nodes of the acceleration structure are reordered to have vertices with consecutive indices;
store the acceleration structure in the storage medium; and
process the primitives using the acceleration structure.

17. The computer-implemented system of claim 16, wherein the one or more processors compress the sorted primitives within the one or more leaf-nodes.

18. A non-transitory computer-readable medium holding one or more computer-executable instructions to:
receive a data set containing a plurality of geometric primitives, wherein the geometric primitives of the plurality of geometric primitives include one or more vertices;
sort the one or more vertices using a first ranking system to calculate one or more revised indices;
re-index the one or more vertices of the geometric primitives using the revised indices;
sort the geometric primitives using a second ranking system;
create a spatial acceleration structure for the data set, wherein the spatial acceleration structure:
describes the plurality of geometric primitives in a multi-dimensional space,
applies a unique index to each of the one or more vertices of the geometric primitives, and
contains one or more leaf-nodes, wherein the one or more leaf-nodes contain one or more geometric primitives of the plurality of geometric primitives;
sort the geometric primitives of the plurality of geometric primitives, within each of the one or more leaf-nodes of the acceleration structure, using a third ranking system, wherein the one or more geometric primitives within each of the one or more leaf-nodes of the acceleration structure are reordered to have vertices with consecutive indices; and
process, by the one or more processors, the primitives using the acceleration structure.

19. The non-transitory computer-readable medium of claim 18, further including computer-executable instructions to compress the sorted primitives within the one or more leaf-nodes.
